(19) United States
(12) Patent Application Publication
(10) Pub. No.: US 2026/0203300 A1
(43) Pub. Date: Jul. 16, 2026

(54) Management system for digital twins, and associated management method

(71) Applicant: ORANGE, ISSY-LES-MOULINEAUX (FR)

(72) Inventors: Thomas Hassan, Rennes (FR); Stéphanie Gerbaud, Chatillon (FR); Philippe Raipin Parvedy, Chatillon (FR)

(21) Appl. No.: 18/877,539

(22) PCT Filed: Jun. 6, 2023
(86) PCT No.: PCT/EP2023/065101

§ 371 Date: Dec. 20, 2024

(30) Foreign Application Priority Data
Jun. 24, 2022 (FR) FR2206301

(51) Int. Cl. G06F 16/27

(52) U.S. Cl. CPC G06F 16/27

(57) ABSTRACT

A digital twin management system including: a module for managing at least one digital twin of an entity, the digital twin being accessible through a telecommunications network, the digital twin including a first set of at least one property with a value that can change over time; and a database connected to the digital twin management module and configured to record representations of digital twins. The representations are compatible with each other, and a representation of a digital twin includes a second set of at least one property with a value that changes over time depending on the change in the value of the at least one property of the first set of the corresponding twin.

### CROSS-REFERENCE TO RELATED APPLICATIONS

This Application is a Section 371 National Stage Application of International Application No. PCT/EP2023/065101, filed Jun. 6, 2023, and published as WO 2023/247172 A1 on Dec. 28, 2023, not in English, which claims priority to and the benefit of French Patent Application No. 2206301, filed Jun. 24, 2022, the contents of which are incorporated herein by reference in their entireties.

### TECHNICAL FIELD

The disclosed technology belongs to the general field of the Internet of Things. It more particularly concerns a digital twin management system. It also concerns a management method implemented by such a digital twin management system.

### DISCUSSION OF RELATED TECHNOLOGY

A digital twin can be defined as a digital replication of a real object or a method, which has the particularity of changing as a function of the transformations of the object or the method to which it is attached. The particularity of a digital twin is to rely on a physical model which is continuously fed by data collected via sensors disposed on or in the vicinity of the real object, or derived from an inspection at a certain time of this object.

Thus, unlike a classic digital modeling, a digital twin is generally configured to provide information at every moment on the current operating state of the real object to which it is linked, but also to simulate a scenario, or even predict or anticipate some situations with regard to the current operation of this object.

In the field of industry, and particularly of aerospace or car manufacturing, the digital twins are increasingly popular because they offer increased surveillance, make it possible to anticipate possible failures and thus facilitate decision-making. They are also increasingly used for monitoring complex systems, such as cities, since they make it possible to include building construction and management data, as well as data from transport and energy networks.

However, conventionally, such complex systems use a plurality of digital twins that are generally designed by different digital twin providers, according to a certain data format, sometimes a proprietary format. These different digital twins, which represent subsystems or real objects of the complex system, are then not interoperable with each other, and the interest of a digital twin of such a complex system is then limited.

For example, in the context of a city, highways, bridges and tunnels, railways, subways, and the other transport infrastructures are generally operated and maintained by multiple operators. Each operator may decide to design a digital twin of the infrastructure it manages, but this is generally done independently of the other digital twins representing the other transport infrastructure of the city. In order for these operators to cooperate more effectively and thus improve the operation, the planning, and the development of the transport infrastructure, it is therefore desirable to improve the cooperation between these different digital twins.

Summary The disclosed technology aims to overcome all or part of the drawbacks of the prior art, in particular those set out above, by proposing a solution that makes it possible to manage a digital twin and to store a representation thereof in a database, without this representation following a predetermined data schema that requires to be stored in said database. The representations can then follow a data schema for example defined by a user of the system according to the case of use of this digital twin.

More particularly, the disclosed technology makes it possible to manage a digital twin independently of its data format, which makes its management and its use flexible.

To this end, and according to a first aspect, the disclosed technology concerns a digital twin management system comprising:
a module for managing at least one digital twin of an entity, said digital twin being accessible through a telecommunications network, said digital twin comprising a first set of at least one property with a value that can change over time;
a database connected to the digital twin management module (100) and configured to record representations of digital twins, the representations being compatible with each other, a representation of a digital twin comprising a second set of at least one property with a value that changes over time depending on the change in the value of the at least one property of the first set of the corresponding twin.

The representations of a database are said to be compatible with each other in the sense that a first representation of a first digital twin can interact with a second representation of a second digital twin, the formats of the first and second digital twins not necessarily allowing this interaction. By interaction, it is meant for example the exchange of data but also the management (generation, change, deletion) of relationships between these first and second representations.

In particular modes of implementation, the system can further include one or several of the following characteristics, taken separately or in all technically possible combinations.

According to one particular implementation, the database is a document-oriented database, and a representation is stored in the database in the form of a document comprising the second set of at least one property.

This implementation is advantageous in that it does not require a predetermined data schema that needs to be stored in said database, and that it makes it possible to store a representation regardless of the format of the associated digital twin, and regardless of the properties of this digital twin.

According to one particular implementation, the management module (100) comprises at least one agent (120) dedicated to the management of a representation and the agent comprises a synchronization module configured to trigger, in response to the determination of a change in the value of the at least one property of the first set, an update of the value of the at least one property of the second set, the update being a function of a synchronization strategy characterizing a synchronization frequency and/or a synchronization state.

This implementation is advantageous in that it makes it possible to avoid congestion related to the simultaneous receipt of a significant number of queries by the digital twin management module.

According to one particular implementation, the digital twin is a physical twin corresponding to a digital replica of the entity, a virtual twin corresponding to a simulation of the entity being associated with this physical twin, and the synchronization state is a state among:
a desynchronization between the entity, the physical and virtual twins, and the corresponding representation;
a synchronization between the entity, the physical and virtual twins, and the corresponding representation;
a replication of the value of at least one property of the physical twin with the value of at least one corresponding property of the virtual twin and a synchronization between the physical twin and the corresponding representation;
a replication of the value of at least one property of the virtual twin with the value of at least one corresponding property of the physical twin and a synchronization between the virtual twin and the corresponding representation.

According to one particular implementation, the database is a graph-oriented database.

The use of a graph-oriented database is advantageous since the relationships between the different entries of the database are stored in the database itself, and do not have to be determined on the fly, upon receipt of a specific query. In this way, the response time is considerably reduced, even for complex queries. Moreover, a graph-oriented database is particularly suitable for the Internet of Things and to the complex systems since it allows storing a large amount of (potentially complex) data, without this affecting the processing of a query in such a base.

According to one particular implementation, the management module is configured to manage at least a first and a second digital twin linked together by a semantic relationship, and the management module comprises an indication that the representations of the first and second digital twins are also linked together.

This implementation is advantageous in that it allows managing a complex system consisting of a large number of interacting twins.

According to one particular implementation, the management module comprises:
a module for receiving an instruction to interact with a digital twin (J);
a module for determining that an agent of said management module has not been previously associated with said digital twin (J);
a module for instantiating an agent associated with said digital twin (J) configured to instantiate said agent in memory dynamically; and,
an instantiation module configured to instantiate a representation.

According to one particular implementation, the agent further comprises:
a module for accessing the digital twin (J); and,
a module for managing at least one set of programming interfaces specifying the methods applicable to the digital twin (J).

According to one particular implementation, the management module further comprises a response module configured to generate a response representative of the success of the application of a method on a digital twin.

According to a second aspect, the disclosed technology concerns a method for managing digital twins by a digital twin management system, the method comprising:
receiving an instruction to interact with a digital twin (J);
determining that no agent of said management module has been previously associated with said digital twin (J);
instantiating an agent associated with said digital twin (J), the instantiation being performed in memory and dynamically; and,
instantiating a representation of a digital twin, based on association data.

In general, it is considered that the steps of a method should not be interpreted as being related to a notion of temporal succession.

According to a third aspect, the disclosed technology concerns a computer program including instructions for the implementation of a management method, when said program is executed by a processor.

According to a fourth aspect, the disclosed technology concerns a computer-readable recording medium on which the computer program according to the disclosed technology is recorded.

### BRIEF DESCRIPTION OF THE DRAWINGS

Other characteristics and advantages of the disclosed technology will emerge from the description given below, with reference to the appended drawings which illustrate one exemplary embodiment thereof without any limitation. In the figures:

FIG. 1A schematically represents a first exemplary embodiment, in accordance with the disclosed technology, of a digital twin management system.

FIG. 1B schematically represents a second exemplary embodiment, in accordance with the disclosed technology, of a digital twin management system.

FIG. 2A schematically illustrates one example of agents associated with digital twins linked together by a semantic relationship.

FIG. 2B schematically illustrates one example of agents associated with digital twins belonging to the same digital twin system.

FIG. 2C schematically represents one example of digital twin systems linked together by a semantic relationship.

FIG. 3A schematically represents one exemplary embodiment, in accordance with the disclosed technology, of a management module 100 belonging to the management system of FIG. 1A or FIG. 1B.

FIG. 3B schematically represents one exemplary embodiment, in accordance with the disclosed technology, of an agent 120 belonging to the management module 100 of FIG. 3A.

FIG. 4 schematically represents one example of hardware architecture of a management module 100 belonging to the management system of FIG. 1A or FIG. 1B.

FIG. 5 represents, in the form of a time diagram, one example of a digital twin management method, as implemented by the management system of FIG. 1A or FIG. 1B.

### DESCRIPTION OF THE EMBODIMENTS

Elements common or similar to several figures bear the same reference signs and have identical or similar characteristics, so that these common elements are generally not described again, for the sake of brevity.

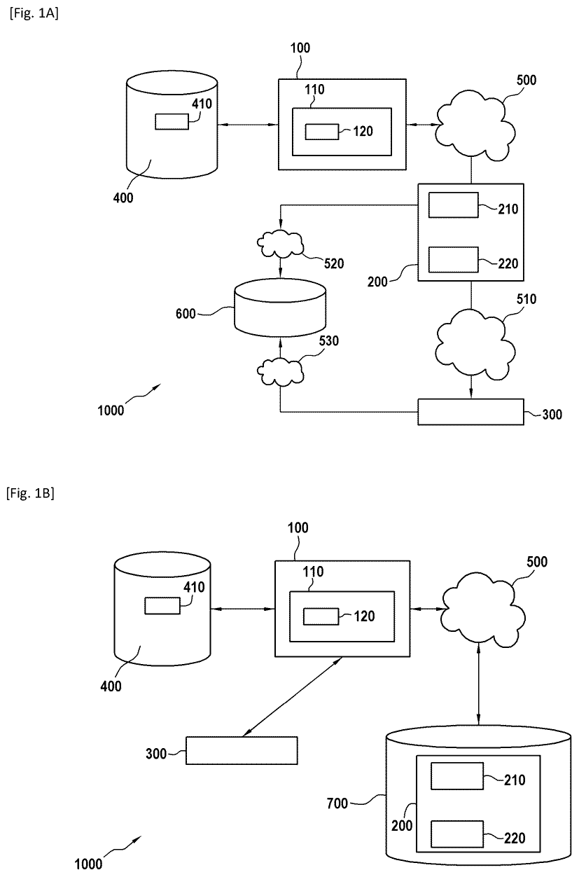

FIG. 1A schematically represents a first exemplary embodiment, in accordance with the disclosed technology, of a digital twin management system.

The digital twin management system 1000 comprises a digital twin management module 100 connected, through a telecommunications network 500, to a digital twin 200. The digital twin management module 100 is also connected to a database 400.

### Data base 400

According to one particular implementation, the database 400 is a NoSQL (Not Only SQL) database. These databases are particularly suitable for the Internet of Things, since they make it possible to store and analyze large volumes of data, without the data necessarily following a predetermined data schema needing to be stored in said database. In other words, the data are not necessarily organized in the form of tables linked together by joins, and it is therefore possible to interact with these databases without using a complex query language. Programming interfaces typically make it possible to manipulate the data by using a language representing structured information, such as XML (extensible Markup Language) or JSON (JavaScript Object Notation).

According to one particular implementation, the database 400 is a document-oriented NoSQL database. Each entry in the database then corresponds to a [key, value] pair. And the value corresponds to a document containing a list of properties, each property being associated with a value which can itself be a list of properties. According to one particular implementation, the document is a JSON or XML type file.

The use of a document-oriented NoSQL database offers the advantage of manipulating structured data (e.g., documents) without a data schema previously defined and needing to be stored in said database being necessary. Moreover, it allows manipulating these documents, and particularly retrieving a set of information structured in a hierarchical manner by using a single key. With a relational database, this operation would be costly in terms of processing resources since it would potentially require performing several joins.

According to one particular implementation, the database 400 is a graph-oriented database. In this case, the relationships between the different entries of the database are stored in the database 400 itself, and do not have to be determined on the fly, upon receipt of a specific query. In this way, the response time is considerably reduced, even for complex queries. Moreover, a graph-oriented database is particularly suitable for the Internet of Things and for the complex systems since it allows storing a large amount of (potentially complex) data, without this affecting the processing of a query in such a base.

### Digital Twin Management Module

Returning to FIG. 1A, the management module 100 comprises a generic module 110 configured to manage a set of at least one agent 120. More specifically, the generic module is responsible for the logical organization in memory of agents 120, including in particular the logical grouping of agents dedicated to twins from the same functional domain or dedicated to the same application, and the generation of semantic relationships between these agents, said generated relationships replicating the links stored in the database between the digital twins.

An agent 120 is configured to process a single digital twin 200, as well as the representation 410 of this digital twin in the database 400. The functionalities of this agent 120 will be described more specifically below. The representation 410 corresponds to an entry in the database 400. Thus, if the database is a document-oriented NoSQL database, the representation 410 corresponds to a document of this base.

### Digital Twin

It should be recalled at this stage that a digital twin can be defined as a digital replication of an entity, e.g., a real object or a method, which has the particularity of changing according to the transformations of the entity to which it is attached.

The digital twin 200 can be either a physical digital twin 210 and in this case it corresponds to a digital replica as closely as possible to a real object 300. As a variant, the digital twin 200 is a virtual digital twin 220 and then corresponds to a simulated or adapted version of the object 300. Concerning this aspect, those skilled in the art may refer to the document “Differentiating Digital Twin From Digital Shadow: Elucidating A Paradigm Shift To Expedite A Smart, Sustainable Built Environment”, Samad M. E. Sepasgozar, Buildings, 11(4), 151. Finally, as a variant, the digital twin 200 comprises a physical digital twin 210 and a virtual digital twin 220. This digital twin 200 is linked to the object 300 it represents, for example through a communication network 510.

Synchronization of the digital twin 200 and of its representation 410 A digital twin 200 is by definition configured to provide at every moment information on the current operating state of the real object 300 to which it is linked, and a fortiori, the same goes for its representation 410 in database 400. In other words, when at least one value of a property of the digital twin changes over time, the value of the corresponding property of the representation changes in a similar manner. According to one particular implementation, the value of the corresponding property of the representation is equal to that of the property of the digital twin. This synchronization is not necessarily immediate, but depends on a synchronization strategy, accessible by the agent 120 managing this digital twin 200, and characterizing a synchronization frequency and/or a synchronization state.

The synchronization frequency generally depends on the type of object, but also on the use made of it. Thus, if the object considered is for example a lamp lighting an agricultural greenhouse depending on the ambient brightness, a synchronization once every 30 minutes will be more than sufficient. If on the other hand the lamp lights an office, a synchronization once per minute will be preferable.

The synchronization state corresponds:
either to a total desynchronization between the real object 300, the physical 210 and virtual 220 digital twins, and a fortiori the corresponding representation 410;
or to a total synchronization between the real object 300, the physical 210 and virtual 220 digital twins, and the corresponding representation 410;
or to a directional synchronization “physical digital twin to virtual digital twin”, that is to say a replication of the values of the properties of the physical digital twin 210 on the values of the corresponding properties of the virtual digital twin 220, then a synchronization between the digital (physical or virtual) twin and the corresponding representation 410; or,
or to a directional synchronization “virtual digital twin to physical digital twin”, that is to say a replication of the values of the properties of the virtual twin 220 on the values of the corresponding properties of the physical twin 210, then a synchronization between the digital (physical or virtual) twin and the corresponding representation 410.

According to one particular implementation, in the event of detection, by an agent 120 or more generally a management module 100, of a desynchronization between the real object 300 and its digital (physical and/or virtual) twin 200 or between the digital twin 200 and its representation 410 in database, said management module is configured to transmit a notification, to a user of the system 1000, comprising an indication that at least some of the components of the system are desynchronized with each other.

### Association Data

It should be recalled that, when at least one value of a property of the digital twin changes over time, the value of the corresponding property of the representation also changes.

The determination of the corresponding property is done through association data. These association data are stored by the agent 120 and define a relationship, which can change over time, between the properties of the digital twin 200 and the properties of its representation 410.

According to one particular implementation, when the digital twin 200 comprises a physical digital twin 210 and a virtual digital twin 220, the database 400 comprises two representations associated with this digital twin 200, each being associated with one of the physical and virtual twins. In this case, the agent 120 managing said digital twin 200 comprises on the one hand first association data linking the properties of the physical twin 210 and the representation of said physical twin, and on the other hand second association data linking the properties of the virtual twin 220 and the representation of said virtual twin.

According to one particular implementation, these association data are hard-coded and defined by a user of the system 1000 for a particular digital twin 200.

As a variant, the association data are determined dynamically, according to a standard or a norm. More specifically, a digital twin 200 complies with a standard, such as DTDL (Digital Twins Definition Language) and whose specification can be accessed from the address https://github.com/Azure/opendigitaltwins-dtdl/blob/master/DTDL/v2/dtdlv2.md; NGSI-LD (defined in document ETSI GS CIM 009V 1.4.1 , Context Information Management (CIM) NGSI-LD API, published in February 2021); SensorThings API (whose specification can be accessed from the address https://github.com/opengeospatial/sensorthings); or WoT TD (Thing Description Ontology—Thing Description) and whose specification can be accessed from the address https://www.w3.org/2019/wot/td. And an association between the properties of the digital twin 200 and the properties of its representation 410 in database can then be deduced.

According to one particular implementation, a software component converts the representation from one or several standard format representations to the representation in database. This component can take advantage of the metadata (e.g. MIME type) of the representation file, indicating which format it is as input.

### Other Particularities

In the example illustrated by this FIG. 1A, the data collected via sensors disposed on or in the vicinity of the real object 300 are recorded in a database 600 connected to the real object 300 through a telecommunications network 530. This database 600 can also be accessed by the digital twin 200 via the telecommunications network 520. The database 600 can also store metadata of the object 300. These metadata comprise for example the creation date, the last update date, the expiration date, the owner (ID), a visibility and/or confidentiality indicator.

The telecommunications networks 500, 510, 520 and 530 can correspond to distinct networks or to the same network. No limitation is attached to the type of telecommunications network, which is for example an Internet network, a Wi-Fi network, or a fixed or mobile telephone network. As a variant, the telecommunications networks 500, 510, 520 and 530 may correspond only to a simple wired or wireless connection.

In the example of FIG. 1A, the digital twin 200 is more specifically an instance of a digital twin, this digital twin having been developed so as to model one particular type of object to which the real object 300 belongs.

FIG. 1B schematically represents a second exemplary embodiment, in accordance with the disclosed technology, of a digital twin management system.

In this example, the digital twin management module 100 is linked to a library 700 of digital twins 200, the twins of the library corresponding to physical digital twins 210, virtual digital twins 220 or comprising both a physical digital twin 210 and a virtual digital twin 220.

The digital twins 200 of the library 700 were developed for one particular type of object. Unlike the example illustrated by FIG. 1A which manipulates already instantiated twins 200, the library 700 stores digital twins 200 which, when stored in the library 700, are not yet instantiated, and a fortiori, are not yet linked to a real object 300.

The instantiation of such a digital twin is implemented, for example when a user of the system 1000 wishes to use a digital twin from the library for an object 300 in his environment. This object 300 is connected, directly or through a telecommunications network (not represented), to the management module 100.

In this example, the database 400 then stores a representation of an instantiation of a digital twin 200 from the library 700 of digital twins.

### Organization of the Digital Twins

If the real object 300 is for example a lamp located in an office, when the lamp actually turns on or off, this change of state should be able to be automatically broadcast to the air conditioning device equipping this office. Symmetrically, the digital twin of the lamp should be linked to the digital twin of the air conditioning device in order to be able to inform it that a value of one of its properties has changed, and thus allow the air conditioning device to turn off when the lamp is off. In this example, the digital twins are therefore linked together by a semantic relationship, and belong to the same system, here a building management system.

More generally, several digital twins 200 can therefore form a complex system that can be represented in the form of a graph, each node corresponding to a digital twin, an arc between two nodes corresponding to a semantic relationship between two digital twins 200. This structuring or hierarchy between the digital twins must also be reflected at the level of the agents managing the representations of these digital twins. As a variant, when a graph-oriented database is used, these relationships are also specified within this database.

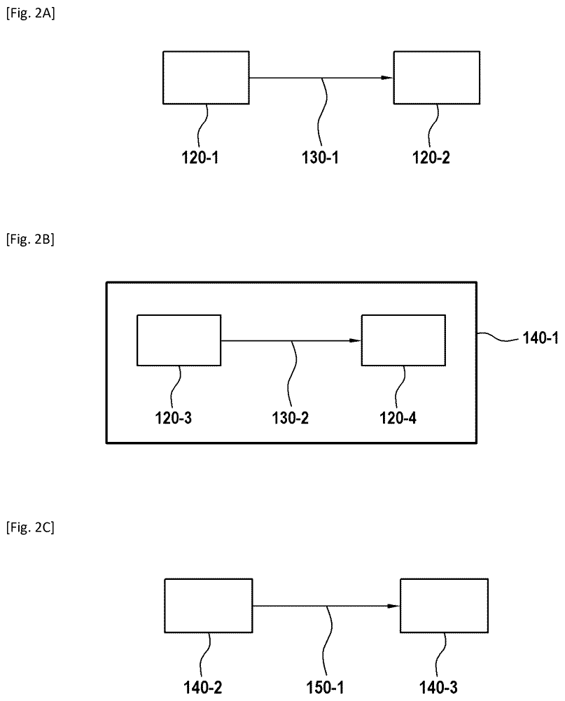

Thus, FIG. 2A schematically illustrates one example of agents 120-1 and 120-2 managing the representations of digital twins linked together by a semantic relationship 130-1. The semantic relationship corresponds for example to “is_part_of”, “is_a”, “is_connected_to”.

FIG. 2B schematically illustrates one example of agents 120-3 and 120-4 managing the representations of digital twins belonging to the same digital twin system. More specifically, the agent 120-3 is linked by the semantic relationship 130-2 to the agent 120-4, and these two agents also belong to the same system 140-1.

FIG. 2C schematically represents one example of two digital twin systems 140-2, 140-3 linked together by a semantic relationship 150-1. The semantic relationship linking two systems corresponds for example to “is_part_of”, “is_a”, “is_connected_to”.

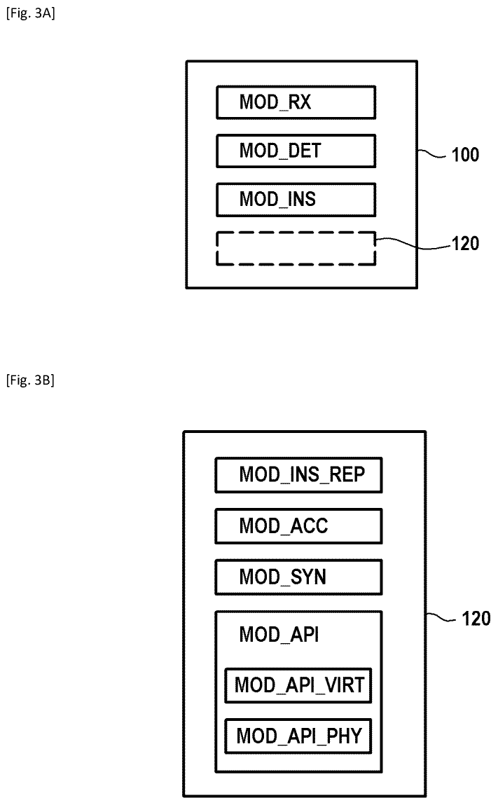

### FIG. 3A, and 3B

FIG. 3A schematically represents one exemplary embodiment, in accordance with the disclosed technology, of a management module 100 belonging to the management system 1000 of FIG. 1A or FIG. 1B.

FIG. 3B schematically represents one exemplary embodiment, in accordance with the disclosed technology, of an agent 120 belonging to the management module 100 of FIG. 3A.

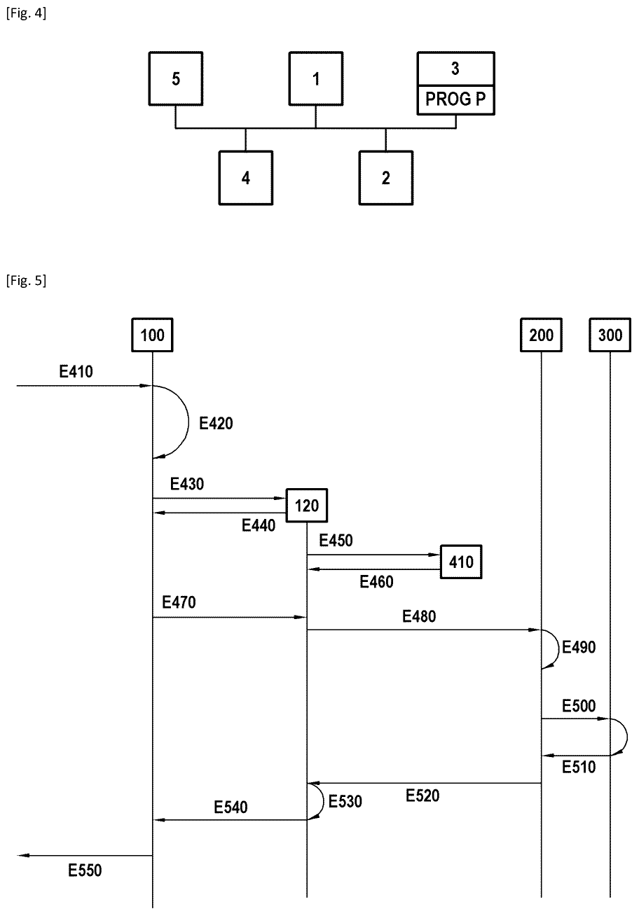

FIG. 4 schematically represents one exemplary hardware architecture of a management module 100 belonging to the management system of FIG. 1A or FIG. 1B.

As illustrated by FIG. 4, the digital twin management module 100 has the hardware architecture of a computer. Thus, the module includes, in particular, a processor 1, a random access memory 2, a read-only memory 3 and a non-volatile memory 4. It further includes a communication module 5.

The read-only memory 3 of the system constitutes a recording medium as proposed, readable by the processor 1 and on which a computer program PROG_P in accordance with the disclosed technology is recorded, including instructions for the execution of steps of the management method as proposed below. The program PROG_P defines functional modules of the management module 100 as represented in FIG. 3A and of the agent 120 as represented in FIG. 3B, which rely on or control the hardware elements 1 to 5 of the management module cited above, and which comprise in particular:
a module MOD_RX for receiving an instruction to interact with a digital twin (J);
a module MOD_DET for determining that no agent of said management module has been previously associated with said digital twin (J);
a module MOD_INS for instantiating an agent associated with said digital twin (J) configured to instantiate said agent in memory dynamically.

Moreover, once instantiated, the agent 120 comprises:
an instantiation module MOD_INS_REP configured to instantiate a representation of said digital twin (J);
a module MOD_AC for accessing the digital twin (j);
a synchronization module MOD_SYN configured to trigger, in response to the determination of a change in the value of a property of the digital twin, an update of the value of the corresponding property of the representation, the update being a function of a synchronization strategy characterizing a synchronization frequency and/or a synchronization state; and,
a module MOD_API for managing at least one set of programming interfaces specifying the methods applicable to the digital twin (J).

Moreover, the management module 100 can also include other modules, in particular for implementing particular modes of the management method, as described in more detail later.

It should be noted that the instruction received by the module MOD_RX for receiving an instruction is issued by a user of the system 1000 wishing to interact with one particular digital twin, or by a control module configured to notify the management module 100 of the recording of a new twin in the database 700.

Moreover, it should also be noted that according to one particular implementation, the query received by the receiving module MOD_RX comprises an indication making it possible to uniquely identify a digital twin 200. This is for example a unique identifier such as a URI (Uniform Resource Identifier). The determination module MOD_DET is then configured to compare this unique identifier with a list of unique identifiers of twins previously instantiated by the management module 100. If the list does not contain the identifier present in the query, this then means that no agent of said management module has been previously associated with the digital twin identified in the query.

The module MOD_ACC for accessing the digital twin can also be configured to implement a process for authenticating the digital twin. This authentication process can use a cryptographic key that is symmetric or asymmetric. As a variant, to increase security in relation to these key-based solutions, an EAP (Extensible Authentication Protocol) type protocol using an authentication server can be implemented.

According to one particular implementation, the module MOD_ACC is also configured to verify that the user who issued the query received by the module MOD_RX has the access rights to apply a certain function on the digital twin (J).

Moreover, it should be noted that the module MOD_API for obtaining at least one set of programming interfaces specifying the methods applicable to the digital twin (J) can comprise a sub-module MOD_API_PHY configured to obtain the programming interfaces specifying the methods applicable to the physical digital twin 210, and a sub-module MOD_API_VIRT configured to obtain the programming interfaces specifying the methods applicable to the virtual digital twin 220.

The communication module 5 of the management module 100 allows it in particular to communicate with the database 400, and with the digital twin 200 or with the library 700 of digital twins, and integrates for this purpose the receiving MOD_RX and access MOD_ACC modules, as well as hardware and software means such as those described above to implement the management method.

FIG. 5 represents, in the form of a time diagram, one example of a digital twin management method, as it is implemented by the management system of FIG. 1A or FIG. 1B.

As illustrated in FIG. 5, the management method comprises a first step E410, implemented by the module MOD_RX for receiving, by the management module 100, an instruction to interact with a digital twin 200. According to one particular implementation, the query received by the receiving module MOD_RX comprises an indication making it possible to uniquely identify a digital twin 200. This is for example a unique identifier such as a URI (Uniform Resource Identifier).

The management method further comprises a step of determining, by the determination module MOD_DET of the management module 100, that no agent of said management module has been previously associated with said digital twin 200. More specifically, this unique identifier is compared with a list of unique identifiers of twins previously instantiated by the management module 100. If the list does not contain the identifier present in the query, this then means that no agent of said management module has been previously associated with the digital twin identified in the query.

If so, a new agent 120 is instantiated in memory dynamically during a step E430 by the instantiation module MOD_INS. This implementation is advantageous in that it optimizes the available memory resource. The method further comprises a step E440 during which the agent 120 transmits a notification to the management module 100 in order to inform it that said agent is correctly instantiated.

During a step E450, a database representation 400 of said digital twin 200 is instantiated. This step is implemented by the instantiation module MOD_INS_REP of the agent 120. In one particular implementation, the instantiation module accesses a database (such as the database 600 of FIG. 1A) and obtains:
information allowing access to the digital twin;
a synchronization strategy associated with the digital twin 200;
a set of programming interfaces specifying the methods applicable to the digital twin 200; and,
association data that define a projection, that can change over time, between the properties of the digital twin 200 and the properties of its representation in the database 400.

The method further comprises a step E460 during which the representation 410 transmits a notification to the agent 120 to inform it that said representation is correctly instantiated.

The query received during the step E410 also comprises a function (f) to be applied to the digital twin 200 and, where applicable, values of the parameters of this function. As a variant, a new query comprising this function (f) and, where applicable, values of the parameters of this function is received by the management module 100. During a step E470, the management module 100 transmits, to the agent 120, the function (f) to be applied to the digital twin 200 as well as the values of the parameters of this function. In response to the receipt of this function, the module MOD_API determines whether this function (f) can actually be applied to the digital twin 200, and if so, the module MOD_ACC determines whether the user who issued the query has the access rights necessary to apply this function (f) to the digital twin 200. If so, an instruction to apply the function (f) is transmitted to the digital twin 200 during a step E480.

In response to the receipt of this instruction, the digital twin 200 implements this function (f) during a step E490, and updates the value of at least one property reflecting the implementation of this function. Thus, if the digital twin represents a lamp, and if the function aims to turn off the lamp, then the digital twin implements this function and the value of the “state” property changes from the value “1” to the value “0”.

If it is synchronized with the object 300 to which it is linked, said digital twin 200 transmits during a step 500 an instruction to the object 300 it represents, so that the latter also implements this function (f). In return, the object 300 returns to the digital twin 200, the value of at least one property having been modified after application of the function (f) during a step E510.

During a step E520, the values of the properties of the digital twin and/or of the object reflecting the implementation of this function (f) are transmitted to the agent 120, which then updates the corresponding representation during a step E530.

Finally, during a step E540, these values are transmitted by a response module of the agent to the management module 100, which transmits them to a display device during a step E550.

According to one particular implementation, the exchanges between the management module and the user, and/or between the management module and the digital twin 200, and/or between the digital twin and the object 300 it represents comply with the HTTP (Hypertext Transfer Protocol) protocol.

According to one particular implementation, the exchanges E510, E520, E540 and E550 comprise a programmatic location of the effect of the implementation of the function (f). In this case, a communication paradigm compliant with HATEOAS (Hypermedia As The Engine of Application State) is for example used.

According to one particular implementation, the exchanges E510, E520, E540 and E550 comprise a time of execution of the function (f) and/or an effective date of end of implementation of the function (f).

The management method has been described so far in the case where the value of at least one property of the digital twin 200 and/or of the object 300 it represents is transmitted to the management module 100, but this method nonetheless remains applicable in the particular case where it is information representative of the failure (or success) of the implementation of this function (f) which is transmitted over the entire processing chain, depending on the synchronization mode.

Although the present disclosure has been described with reference to one or more examples, workers skilled in the art will recognize that changes may be made in form and detail without departing from the scope of the disclosure and/or the appended claims.

1. A digital twin management system comprising:
a database; and
at least one processor connected to the database and configured to:
manage at least one digital twin of an entity, said digital twin being accessible through a telecommunications network, said digital twin comprising a first set of at least one property with a value that can change over time; and
record representations of digital twins, the representations being compatible with each other, a representation of a digital twin comprising a second set of at least one property with a value that changes over time depending on the change in the value of the at least one property of the first set of the corresponding twin.

2. The management system according to claim 1, wherein the database is a document-oriented database, and the representations comprise a representation being stored in the database in the form of a document comprising the second set of at least one property.

3. The management system according to claim 2, wherein the at least one processor is configured to implement at least one agent dedicated to the management of a representation recorded in the database, said agent comprising a synchronization module configured to trigger, in response to a determination of a change in the value of the at least one property of the first set, an update of the value of the at least one property of the second set, the update being a function of a synchronization strategy characterizing a synchronization frequency and/or a synchronization state.

4. The management system according to claim 3, wherein said digital twin is a physical twin corresponding to a digital replica of the entity, a virtual twin corresponding to a simulation of the entity being associated with the physical twin, and the synchronization state is a state among:
a desynchronization between the entity the physical and virtual twins, and the corresponding representation;
a synchronization between the entity, the physical and virtual twins, and the corresponding representation
a replication of the value of at least one property of the physical twin with the value of at least one corresponding property of the virtual twin and a synchronization between the physical twin and the corresponding representation;
a replication of the value of at least one property of the virtual twin with the value of at least one corresponding property of the physical twin and a synchronization between the virtual twin and the corresponding representation.

5. The management system according to claim 1, wherein the database is a graph-oriented database.

6. The management system according to claim 1, wherein the at least one processor is configured to manage at least a first and a second digital twin linked together by a semantic relationship, the at least one processor comprising an indication that the representations of the first and second digital twins are also linked together.

7. The management system according to claim 1, wherein the at least one processor is configured to:
receive an instruction to interact with a digital twin;
determine that an agent of said a least one processor has not been previously associated with said digital twin;
instantiate an agent associated with said digital twin configured to instantiate said agent in memory dynamically; and
instantiate a representation.

8. The management system according to claim 7, wherein the at least one processor is configured to implement at least one agent dedicated to management of a representation, said at least one agent comprising a synchronization module configured to trigger, in response to a determination of a change in the value of the at least one property of the first set, an update of the value of the at least one property of the second set, the update being a function of a synchronization strategy characterizing a synchronization frequency and/or a synchronization state,
wherein the at least one agent further comprises:
a module for accessing the digital twin; and,
a module for managing at least one set of programming interfaces specifying the methods applicable to the digital twin.

9. The management system according to claim 1, wherein the response at least one processor is configured to generate a response representative of a success of an application of a method on a digital twin.
